(19) United States
(12) Patent Application Publication
(10) Pub. No.: US 2014/0006122 A1
(43) Pub. Date: Jan. 2, 2014

(54) SYSTEMS AND METHODS FOR MANAGING DISCOUNT VOUCHERS

(71) Applicant: Jason W. Barker, San Lorenzo, CA (US)

(72) Inventor: Jason W. Barker, San Lorenzo, CA (US)

(21) Appl. No.: 13/536,334

(22) Filed: Jun. 28, 2012

(51) Int. Cl. G06Q 30/02

(52) U.S. Cl. 705/14.15

(57) ABSTRACT

A first voucher having a voucher purchase price and a discount offer is provided to a first user. The discount is specified as a price reduction or credit applicable towards purchasing a good or service. The first voucher is provided from a platform that is configured to provide a plurality of vouchers, including the first voucher, for a plurality of discounts offered by a plurality of different merchants. After the first user purchases the first voucher at the voucher purchase price in a first transaction, a monetary or fiat currency reward is remitted to one or more users, including the first user. The reward is related to at least a portion of proceeds that were obtained from voucher transactions with respect to a sale of one or more vouchers that occurred prior to the first transaction or wherein such reward is related to proceeds from another source.

### TECHNICAL FIELD OF THE INVENTION

The present invention relates to facilitating consumer purchasing of merchandise and services, and more specifically to managing promotions for purchasing merchandise and services.

### BACKGROUND

Consumers have had access to numerous sources for deals, offers, promotions, give-aways and coupons to encourage the consumption of merchandise and/or services provided by merchants. Such incentives may take the form of discounts that are offered through use of coupons that are, in many instances, freely provided to consumers.

Consumer incentives for purchasing goods or services may also be provided in the form of promotional offerings to potential consumers via a computer network, e.g., the Internet. That is, promotional offerings are made available to consumers through email or websites. One approach entails presenting consumers with an offer from a merchant that is made freely available to the consumer. For example, the consumer can obtain an electronic coupon, which can be printed or displayed on a mobile device for presentation to the merchant. Another approach involves presenting the consumer with an offer that provides a mechanism for the consumer to purchase the merchandise or service at a discounted price either directly or in-directly through the entity that is presenting the offer.

### SUMMARY OF THE INVENTION

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments pertain to providing a computer-implemented voucher system that allows users to purchase vouchers that relates to a discount or promotional offers for purchasing goods or services. A promotional offer may include a rebate, purchase credit, or price discount related to a good or service. In one embodiment, a user can purchase a voucher for a nominal fee that is less than the discount amount obtained by use of the voucher to purchase the good or service or less than the price of the good or service after the discount of the voucher has been applied to purchasing such good or service. In other embodiments, the voucher is the promotional offer itself. In certain aspects, at least a portion of the proceeds from the fees collected from users purchasing the vouchers can then be used to reward at least some of the voucher users. A reward can be remitted irrespective of whether the voucher users use their purchased vouchers to actually buy the associated good or service. In alternative or additional embodiments, certain aspects of how the voucher platform provides vouchers to a particular user depend on such user's membership in a particular group of associated users set up within a social network application and/or the activities of one or more of the associated users.

In one embodiment, a method for selling a discount or promotional voucher to a user of a mobile or data network is disclosed. In operation (a), a first voucher, which specifies both a voucher purchase price for purchasing such first voucher and a discount of an original purchasing price for purchasing a good or service from a first merchant using such first voucher, is provided to a computing device that is associated with a first user and that is configured to display such first voucher on a display of such computing device. The discount is specified as a price reduction, a buyer credit or a rebate that is applied to the original purchase price by use of such first voucher to purchase the good or service, and the first voucher is provided from a platform that is configured to provide a plurality of vouchers, including the first voucher, for a plurality of discounts offered by a plurality of different merchants. The voucher purchase price for purchasing the first voucher is less than the discount that is obtainable by use of such first voucher to purchase the good or service and is less than a price of the good or service after the discount has been applied, if determinable from the terms of the voucher. The method further comprises operation (b): after the first user purchases the first voucher at the voucher purchase price in a first transaction, remitting to one or more users, including the first user, a monetary or fiat currency reward that is related to at least a portion of proceeds that were obtained from a plurality of voucher transactions with respect to a sale of one or more of the plurality of vouchers that occurred prior to the first transaction or wherein such reward is related to proceeds from another source.

In a specific implementation, the reward is related to at least a portion of proceeds that were obtained from a plurality of voucher transactions with respect to a sale of one or more of the plurality of vouchers that occurred prior to the first transaction. In this implementation, prior to providing the first voucher to the computing device of the first user, a second voucher is provided to a second computing device that is associated with a second user and that is configured to display such second voucher on a display of such second computing device, and the second voucher is provided to the second computing device from the platform. In this embodiment, after the second user purchases the second voucher at a second voucher purchase price in a second transaction, such second voucher purchase price is collected as part of the proceeds that were obtained from the plurality of transactions that occurred prior to the first transaction without remitting any portion of such proceeds to the second user in response to the second transaction.

In another embodiment, the reward is represented in the platform as a fiat currency. In yet further aspect, the fiat currency is specified as a plurality of named credits or purchase points, which are divisible into fractional units to facilitate division and allocation of such fiat currency across multiple users, merchants, or other entities. In another implementation, a pre-pay option is provided to the computing device of the first user, and such pre-pay option is for the first user to purchase a plurality of monetary or fiat currency credits that can later be used to purchase one or more of the plurality of vouchers. In another aspect, the first voucher is integrated into a digital payment mechanism for the first user to purchase the good or service via a mobile or data network.

In another embodiment, a give-away promotion is provided with the first voucher so that the first user is eligible to receive a free merchant offering following said first user's acquisition of the first voucher in response to a calculation that the free merchant offering is to be provided to the first user. An aspect of the calculation can be specified by the first merchant. In another implementation, a location of the first user is determined, and the first voucher is provided to the computing device of the first user based on determining that a place of business for the good or service of the first voucher is proximate to the location of such first user.

In a further aspect, the method includes repeating operation (a) for each of a first plurality of users to purchase selected ones of the plurality of vouchers from selected ones of the different merchants via the platform, and repeating operation (b) for each of a second plurality of users, and wherein a monetary or fiat currency reward is remitted to one or more of the second plurality of users even if such one or more users have purchased vouchers and have not used their purchased vouchers to purchase associated goods or services. In a further aspect, whether to remit the reward to one or more users and/or a variable used in the calculation of the amount of the reward provided to such one or more users is based on a metric pertaining to all or a portion of such one or more of the plurality of users' past aggregation of activities in relation to the plurality of vouchers or a plurality of related merchant transactions. In another aspect, an amount of the discount specified by one or more vouchers that are provided to one or more of the plurality of users is based on a metric pertaining to all or a portion of such one or more of the plurality of users' past aggregation of activities in relation to the plurality of vouchers or a plurality of related merchant transactions. In yet another aspect, the reward to one or more of the plurality of users also includes bonus credits to the one or more of the plurality of users from one or more of the different merchants based on a metric pertaining to all or a portion of such one or more of the plurality of users' past aggregation of activities in relation to the plurality of vouchers or a plurality of related merchant transactions.

In yet another example, one of the remitted rewards is remitted to an associated subset of the plurality of users that are all directly associated to at least one same user through a social network application and such remitting is based on whether user information pertaining to the associated subset of users, which is accessible by the platform, meets one or more aggregate criteria pertaining to said associated subset of users that is specified by the first merchant. In another aspect, the reward has a value that is selected from a pre-determined plurality of increasing or decreasing values that each depend on whether user information pertaining to the first or second plurality of users meets one or more user activity criteria. In another aspect, the reward includes bonus credits provided from the first merchant and a value of such bonus credits are selected from a pre-determined plurality of increasing or decreasing levels that each depend on whether user information pertaining to the first or second plurality of users indicates that such first or second plurality of users meets one or more user activity criteria specified by the first merchant. In another implementation, a discount of at least one of the provided vouchers is selected from a pre-determined plurality of increasing or decreasing values that each depend on whether user information pertaining to the first or second plurality of users meets one or more user activity criteria.

In a further embodiment, the method includes receiving a plurality of gifts that are specified by a plurality of giving users to be offered to selected one or more of the first or second plurality of users, wherein each gift is in the form of 1) monetary credit units for buying vouchers that the giving user previously acquired, 2) monetary credit units that have been remitted to said giving user, or (3) a voucher; and providing such gifts to such selected one or more of the first or second plurality of users. In a further aspect, one or more of the plurality of gifts specify limitations on use of said gift.

In another aspect, the second plurality of users include a plurality of associated users to which a reward is remitted based on a determination that such plurality of associated users are associated with each other by a direct association each associated user has with at least one of the first plurality of users through a social network application, wherein the association exists independently of the plurality of vouchers and use of such vouchers. In a further embodiment, an amount of the reward is remitted to one or more of the associated users based on a metric pertaining to all or a portion of such associated users' collective utilization of the plurality of vouchers or a plurality of related merchant transactions. In a further aspect, the amount of the reward selected from a pre-determined plurality of increasing or decreasing values that are specified by the first merchant. In another feature, the reward is in the form of bonus credits provided by the first merchant and wherein use of such bonus credits is limited to vouchers, goods or services that pertain to the first merchant. In one implementation, the bonus credits are allocated based on all or a portion of said associated users' collective activities with respect to the plurality of vouchers or a plurality of related merchant transactions. In another implementation, an amount of the discount of the first voucher as provided to the first user is based on a metric that pertains to a collective or individual activity that is performed by one or more of the associated users with respect to the plurality of vouchers or a plurality of related merchant transactions. In a further aspect, the amount of the discount is selected from a pre-determined plurality of increasing or decreasing values that are specified by the first merchant.

In yet another embodiment, the first voucher is provided to the first user based on user information pertaining to the first user, which is accessible by the platform, meeting one or more user criteria that are specified by the first merchant. In another aspect, the discount's amount depends on whether user information pertaining to the first user, which is accessible by the platform, meets one or more user criteria that are specified by the first merchant. In another feature, the reward includes bonus credits provided by the first merchant that are remitted based on one or more criteria pertaining to a plurality of users that are specified by the first merchant and such bonus credits are remitted based on user information that is accessible by the platform, wherein use of the bonus credits are limited to transactions pertaining to the first merchant.

In another embodiment, the invention pertains to an alternative method for providing rebates, credits or price discounts to a plurality of users of a platform that is accessible via a mobile communications network or a data network. A first promotional offer, which is provided by a first merchant, is provided to a client device of a first user. The first promotional offer pertains to a rebate, purchase credit, or price discount related to a good or service. The platform is configured to provide a plurality of promotional offers, including the first promotional offer, which promotional offers are provided by a plurality of different merchants. At the platform, association information pertaining to the first user is obtained. The association information specifies that the first user belongs to a plurality of associated users, including the first user, and the associated users each have a direct association with the first user through a social network application. Such direct association exists independently of the first promotional offer and use of such first promotional offer. The first promotional offer is provided or an amount of the rebate, purchase credit, or price discount is activated for the first user in response to the obtained association information indicating that one or more criteria are met by two or more associated users performing with respect to the first promotional offer or other promotional offers (a) one or more transactions prior to providing the first promotional offer to the first user or (b) at least two transactions before, during, or after providing the first promotional offer to the first user.

In a specific implementation, the first promotional offer is provided to a client device of the first user in response to the obtained association information that is related to a) one or more prior transactions or b) two or more transactions that are specifically related to the first merchant. In another aspect, the amount of the rebate, purchase credit, or price discount is activated for the first user in response to the obtained association information that is related to a) one or more prior transactions or b) two or more transactions that are specifically related to the first merchant. In another embodiment, the first promotional offer takes the form of a first voucher that is purchasable by the first user at a price that is equal to a full discounted price of the merchandise or service being offered in the first promotional offer. In yet another embodiment, the method further includes remitting a reward or rebate, which is related to a portion or all of proceeds obtained from a) one or more of the plurality of users who purchased one or more of a plurality of vouchers for the first promotional offer or other promotional offers or b) another source, to one or more of the associated users based on the associated users' use of one or more of the plurality of vouchers or a plurality of related merchant transactions.

In another specific implementation, the rebate, purchase credit or price discount is selected from a pre-determined plurality of increasing or decreasing values with said selection based upon information indicating that one or more criteria are met by two or more associated users performing with respect to the first promotional offer or other promotional offers (a) one or more transactions prior to providing the first promotional offer to the first user or (b) at least two transactions before, during, or after providing the first promotional offer to the first user. In one aspect, at least a portion of the transactions are handled outside the platform.

In an alternative embodiment, the invention relates to a method for providing rebates, credits or price discounts to a plurality of users of a platform that is accessible via a mobile communications network or a data network. This method comprises (a) providing a first voucher, at a price that is equal to a full discounted price of a merchandise or service being offered, to a computing device that is associated with a first user and that is configured to display such first voucher on a display of such computing device. The first voucher is provided from a platform that is configured to provide a plurality of vouchers from a plurality of different merchants. The method further comprises (b) after the first user purchases the first voucher at the voucher purchase price, remitting a reward, which is obtained from a portion or all of proceeds obtained from users who buy the first voucher or from another source, to the first user based on said first user's purchase of two or more of the plurality of vouchers via the platform or based on said first user's completion of two or more related merchant transactions.

In one aspect, the reward remitted to the first user is a percentage of proceeds from the first user purchasing the two or more vouchers, wherein such percentage varies based on an aggregate voucher amount from the proceeds from the first user purchasing two or more vouchers. In other embodiments, this method also includes one or more of the features recited above.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 is a flowchart illustrating an overview of a voucher management procedure in accordance with one embodiment of the present invention.

FIG. 2 is a simplified diagram of a network environment in which specific embodiments of the present invention may be implemented.

FIG. 3A illustrates an example user interface for a merchant to provide offer set-up information to a voucher management system in accordance with a specific implementation of the present invention.

FIG. 3B illustrates one example implementation of a user interface for offering vouchers via a voucher management system to a user in accordance with one embodiment of the present invention.

FIG. 4 is a flowchart illustrating a procedure for handling voucher purchasing in accordance with one example implementation.

FIG. 5 is a flowchart illustrating a reward management procedure in accordance with a specific embodiment.

FIG. 6 illustrates a typical computer system that, when appropriately configured or designed, can serve as a system of this invention.

### DETAILED DESCRIPTION OF THE SPECIFIC EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

In general, certain embodiments pertain to providing a computer-implemented system that allows users to purchase vouchers that relates to discount or promotional offers, such as coupons, for purchasing goods or services. A promotional offer may take any form, such as a rebate, purchase credit, or price discount related to a good or service. In one embodiment, a user can purchase a voucher for a nominal fee that is less than the discount amount obtained by use of the voucher to purchase the good or service or less than the price of the good or service after the discount of the voucher has been applied to purchasing such good or service. In other embodiments, the voucher is the promotional offer itself.

In certain aspects, at least a portion of the proceeds from the fees collected from users purchasing the vouchers can then be used to reward at least some of the voucher users. A reward can be remitted irrespective of whether the voucher users use their purchased vouchers to actually buy the associated good or service. In alternative or additional embodiments, certain aspects of how the voucher platform provides vouchers to a particular user depend on such user's membership in a particular group of associated users set up within a social network application and/or the activities of one or more of the associated users.

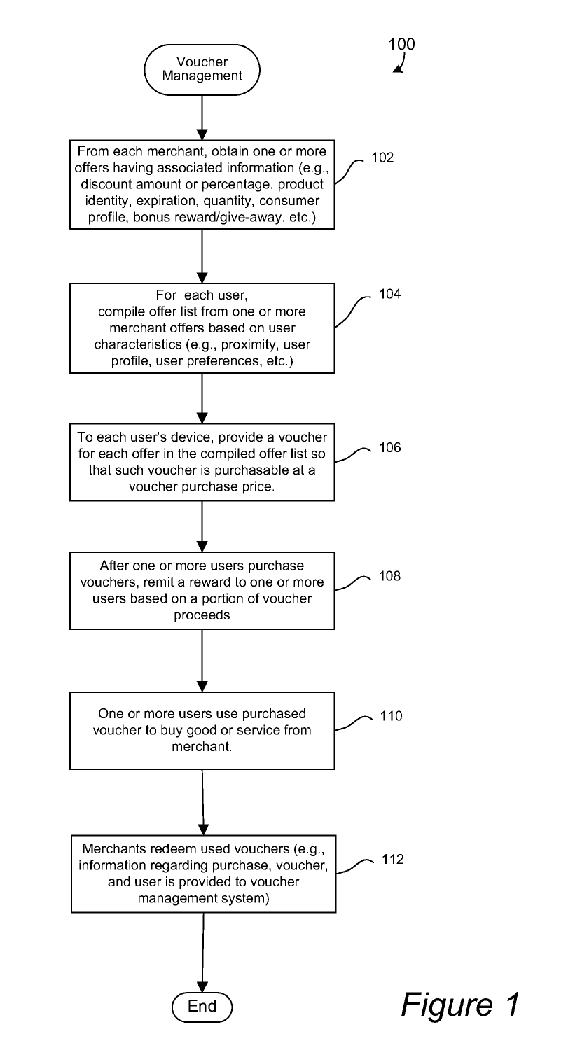

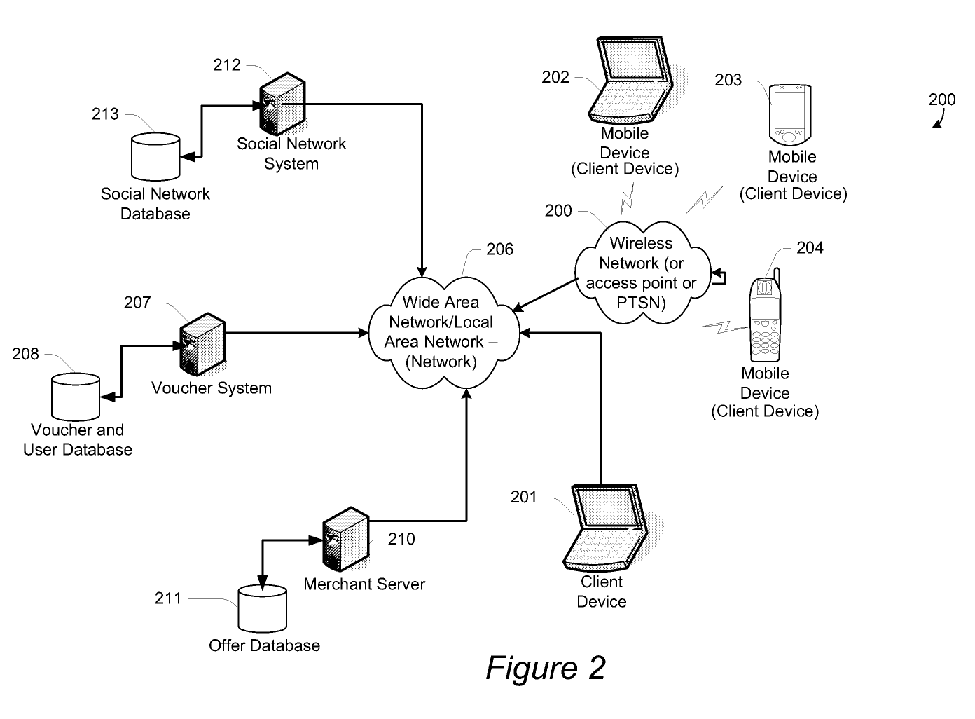

FIG. 1 is a flowchart illustrating an overview of a voucher management procedure 100 in accordance with one embodiment of the present invention. In general, a voucher management system may be implemented with any suitable combination of hardware and software. FIG. 2 is a simplified diagram of an example network 200 in which specific embodiments of the present invention may be implemented. FIG. 2 will be described herein in conjunction with the procedures illustrated herein as example network components for serving or implementing a voucher platform. Detailed network examples are also described further below.

Referring back to FIG. 1, one or more offers may initially be obtained from each of a plurality of different merchants in operation 102. Offers may be obtained at any time during the process. For example, as shown in FIG. 2, a merchant may access a voucher management system 207 from client device 201 in conjunction with using a merchant server 210 and offer database 211, which together can handle offers and product sales.

The voucher management system 207 may be accessible through a web site available from a system of servers, by way of example. Additionally, the voucher management system 207 may allow access to a downloadable application or browser plug-in that is downloadable and executable on a client device, such as a tablet computing device, laptop computing device (e.g., 202), personal digital assistant or PDA (e.g., 203), mobile phone (e.g., 204), desktop computer, etc. Each downloaded voucher application or browser plug-in may then operate in cooperation with the voucher system 207.

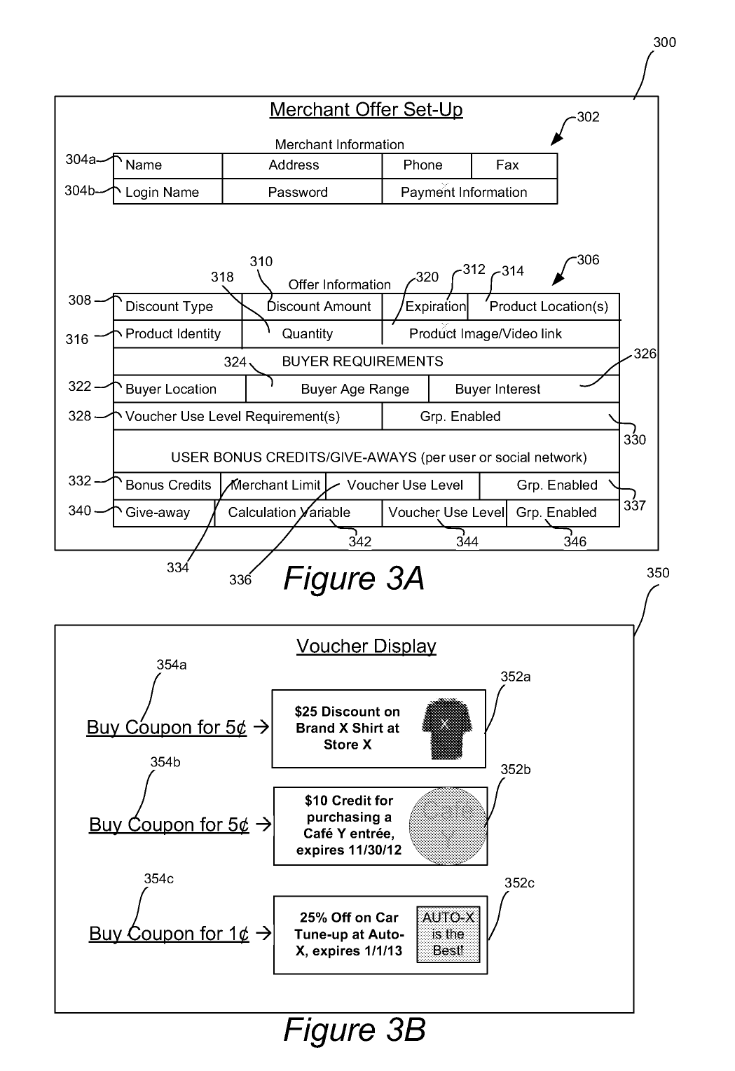

The voucher management system may include any suitable mechanism for obtaining offers from merchant users. For example, the voucher management system may provide a graphical user interface (GUI), such as the interface 300 shown in FIG. 3A, to each merchant accessing a web site or downloaded application of the voucher system. As shown, the GUI 300 may include a merchant information portion 302 for entering data pertaining to the merchant and an offer portion 306 for the merchant to enter data for each offer. For example, the GUI may include input mechanisms (e.g., pull-down menus, fillable fields, etc.) for entering any suitable type and number of data pertaining to each merchant and each merchant's one or more offers. Alternatively, the system may provide for a speech-recognition based interface, for example.

The merchant input portion 302 may include any suitable input fields for obtaining merchant information. As shown, the merchant input portion 302 includes fields for a name (e.g., 304a), address, phone number, fax number, login name (e.g., 304b), password, payment information (e.g., credit/debit card or bank account information).

Although only one offer input portion 306 is illustrated in FIG. 3A, the voucher management system may present any suitable number of offer input portions for entering data for multiple offers. Additionally, the voucher system GUI or other interface may be arranged to allow each merchant to enter information for each offer or to enter information for all or a portion of their offers at one time.

As shown, the offer input mechanism 306 may allow the merchant to enter one or more of the following data for each offer: a discount type 308, a discount amount 310, expiration 312, product location(s) 314, product identity 316, quantity 318 (e.g., limit), and product image/video link 320. Other types of offer data may include minimum purchase price for a good or service discount to be applicable, a description of the product or service, general information regarding the merchant, general terms and conditions of the offer, a description of how to redeem the offer, merchant contact information such as phone number, email address, website address, physical merchant location addresses, directions or a map to one or more merchant locations, etc.

The discount type 308 may specify whether the offer is a purchase credit, price reduction, or rebate that is specified in monetary units or percentages. The discount amount 310 may specify the actual discount amount that is being taken off the original price of the particular good or service, the credit amount for purchasing the particular good or service, or the rebate amount. An absolute monetary amount or a percentage amount may be specified. The expiration 312 may specify the duration of time or specify a particular expiration date after which the offer will expire. A merchant may also specify no expiration for an offer. The product location 314 may specify one or more physical and/or web addresses at which the good or service may be purchased, for example, using the purchased voucher. The product identity 316 may specify product name, brand, model number, service description, bar or QR code, etc. The product quantity 318 may specify a quantity limit on the number of goods or service quantification amounts for which this offer applies. The product image/video link 320 may be a link (universal resource locator or URL) to an image or video or may contain an embedded image or video that describes or shows the good or service being offered.

The voucher system may also provide a GUI or other interface to allow a merchant to specify user demographic requirements that the merchant wishes to be met before a particular user can be presented with a voucher for a particular offer. In general, the voucher system may provide one or more input mechanisms for merchants to specify any number and type of demographic requirements that users are preferably to meet before being presented with one or more vouchers or offers. The merchant may be allowed to specify a set of user demographic requirements or other user specific criteria for applying to individual offers, a portion of their offers, or all their offers. In the illustrated example, the voucher system can be configured to allow the merchant to specify one or more of the following potential buyer requirements for each offer: buyer location 322, buyer age range (or limit) 324, buyer interest 326 (or demographic limits), and voucher use level 328. Other potential buyer requirements may include gender, income level, occupation, education level, measure of wealth or assets, place of birth, date of birth, hobbies, specified favorite things (such as music categories, specific songs, movie categories, specific movies, specific products or merchants, favorite color(s), favorite activities, favorite holidays), buyer rankings or other information based on purchase history, etc.

The buyer location 322 may specify a particular geographical location requirement, such as postal code, neighborhood, city, state, and/or country. The buyer age range 324 may specify a maximum or minimum age or a particular age range. The buyer interest 326 may require users to express interest in particular categories. For example, only users who specify that they are interested in automobiles are provided vouchers pertaining to automobile discounts. The buyer interest may also pertain to a user's occupation or area of expertise.

The voucher use level 328 may specify any number or type of voucher use metrics that the potential customer is required to reach before certain aspects of the voucher are provided to the user, such as discount amount or voucher purchase price. The term “voucher use level” corresponds to requirements for any type and number of transactions with respect to vouchers, including activities for purchasing vouchers and using vouchers to purchase a good or service at a specified discount (e.g., in the form of a credit or price reduction).

Additionally, other requirements may correspond to merchant transactions that were processed or transacted outside of the platform, irrespective of whether or not such transactions involved the use of a voucher. In general any measure of user transaction activity as described herein may include related merchant transactions processed by a third party with such transactions being related to one or more users. Additionally, it is not a requirement that such related merchant transactions involve the use of a voucher. For instance, transactions can correspond to a user's use of a credit/debit card that is registered with the platform service or such data is available to the platform from a 3^{rd} party. In another example, a merchant can provide the platform directly with information related to a particular user's activity. Another example includes a third party information service provider or alternative transaction processor (e.g. Google Wallet) providing the platform with the merchant related transaction data.

A merchant may specify one or more of the following voucher use metrics, e.g., as one or more voucher use levels: total number of purchased vouchers, total monetary amount of purchased vouchers, total number of completed transactions on the voucher platform, total monetary amount of goods or services purchased with or without purchased vouchers, total quantity of goods or services purchased, total number of logins to the platform, total number of invitations to friends to join the platform or acquire a voucher, total number of vouchers (or total voucher amount) acquired or utilized during a specified time period, total number of vouchers (or total voucher amount) acquired or utilized with respect to a specific merchant or a specific product/service, total number of transactions (or total transaction amount) related to a specific merchant completed during a specified time period, total number of transactions (or total transaction amount) transacted with respect to a specific merchant or a specific product/service, or other similar metrics as pertain to the aggregate activities of a user and/or their associated friends, etc.

At least some of the transactions for meeting a voucher use requirement may occur prior to a user's current attempt to purchase a voucher. That is, past voucher activity levels may be applied to meeting voucher use metrics requirements in order for a user to be presented with particular voucher offers. For example, if a particular voucher offer has a voucher purchase level requirement that is to be met to allow a user to purchase the particular voucher, a user must have purchased the required “voucher purchase level” number or threshold of vouchers via the voucher management system or platform in order to be allowed to purchase the particular voucher. The current or to-be-done voucher purchase may also count towards a voucher purchase requirement in certain embodiments.

Other types of voucher activities may also be used to meet voucher use metric requirements. For example, a user may receive a particular voucher discount or receive a particular voucher purchase price if a particular voucher use metric is reached. As described further herein, a particular voucher discount may become active for a purchased voucher after the user has purchased such voucher.

The voucher system may be configured to allow the merchant to specify one or more voucher use requirements for all or a portion of such merchant's offers, rather than for each offer (as shown). The voucher system may be configured to apply the required voucher use level on a per merchant basis or to automatically apply the required voucher use level to all merchants from which a user has purchased vouchers through the voucher platform. The voucher system may also allow the merchant to specify which one or more merchants for which the required voucher use level is applicable. That is, a user's voucher use may not count towards meeting a required voucher use level if such voucher use did not pertain to the merchant to which the voucher use level is limited. In sum, the voucher use level may apply to a particular merchant, all merchants, a particular voucher, or all vouchers. Additionally, a particular one of these applications may be automatically implemented by the voucher system or selectable by a merchant.

The voucher platform may also be configured to allow a merchant to specify a bonus credit 332 to be remitted to users in the form of voucher purchase or discount credits (or cash) or points. The platform may also be configured to require the merchant to purchase the specified bonus credits so that this money collected from the merchants can be used by the platform to cover the bonus credits that are then given to the voucher users. In other embodiments, the platform is configured to allow a merchant to use a portion of the voucher purchase proceeds, which were collected for remitting to the merchant, as bonus credits. The platform may also allow a merchant to specify a merchant limit 334 and/or voucher use level 336 for each bonus credit amount. The bonus credits can also be in a form so that a receiving user can use the bonus credits to either purchase vouchers or purchase goods or services from the giving merchant.

The platform may also allow a merchant to specify a give-away 340 to be given to users who purchase vouchers, based on a give-away calculation or chance-based technique for randomly giving away winnings to certain users. Winnings may include cash, purchase credits, free vouchers, free goods or services or other items of monetary value. One or more variables or aspects of the give-away calculation may also be specified by the merchant (e.g., via field 342). The calculation variable or aspect may be specified in terms of a probability, timing, or count by way of examples. For instance, the merchant may specify that 1 in 50 users who buy the particular voucher will receive the specified give-away amount or credit. Alternatively, the merchant may specify that every predefined number of voucher purchasers will trigger the next voucher purchaser to receive the specified give-away. The platform may also allow the merchant to specify a voucher use level 344 requirement for the give-away. The voucher platform may also be arranged to receive payment from the merchant for any give-away amounts or credits or use a portion of voucher proceeds that were retained for remitting to the merchant as reimbursement for the cost of all or a portion of the give-away.

As described further herein, the platform may also allow a merchant to specify that any of the above described voucher use level requirements be applied based on the actions of one or more users in a group of users who are each directly associated with at least one same other group member. Of course, alternative embodiments may allow indirect associations between peoples, such as 2^{nd} or 3^{rd} level relations (e.g., friend of a friend, etc.) The platform may implement this feature in any suitable manner such as a simple “group enabled” field or button. As shown, a merchant may enable a group function as described herein for a voucher use requirement being applied to an offer's voucher use level (via enable group field 330), bonus credit's voucher use level (via enable group field 337), and/or a give-away's voucher use level (via enable group field 346).

In a specific example, a merchant can specify that bonus credits or a give-away be given to all or a portion of the users of an associated group who are each directly associated with at least one same group user via a social network application when an individual user of the associated group meets the specified requirements for the bonus credit or give-away. Alternatively, a merchant can specify that all or a portion of the users of an associated group be rewarded with a bonus credit when two or more users in the associated group collectively meet the particular requirement, such as voucher use level.

A merchant can also be allowed to set up an offer with one or more discount amounts or a discount limit that each depends on whether one or more user activity criteria are met. For instance, a discount amount becomes active after a user has acquired a certain number of vouchers. That is, a particular user acquires a voucher or conditionally commits to buy a voucher that includes a varying discount amount that changes after the voucher purchase or prior to voucher activation in response to certain user activity (by the particular user, the particular user's associated user group, or all or a subset of voucher users) being met. In one example, a merchant can set up a discount amount for a particular voucher and its associated offer that decreases as more users purchase or use the particular voucher (e.g., to purchase goods or services). The merchant can also specify a limit on discount liability on the number of users using the particular discount offer. When a certain number of users acquire an offer, the offer then becomes no longer available. Conversely, the discount of a particular offer can increase in predefined increments for each predefined increase in the number of users who purchase or use the voucher. Also, the platform interface can be configured to show a counter indicating how many people have already purchased or used a voucher for a particular varying discount offer.

In an increasing discount amount example, the first 100 users to use a particular offer will receive a 5% discount; the next 100 will receive a 10% discount; and everyone else will receive 15%. In a decreasing discount amount example, the first 100 customers to use a particular offer will receive a 20% discount; the next 100 customers will receive a 10% discount; and the next 100 customers will receive a 5% discount, while for any remaining customers the offer is no longer valid. In other examples, the discount amounts can be based on the number of users who buy vouchers or on the number of vouchers sold, rather than the number of users who buy goods or services.

Similarly, a merchant can also be provided with a mechanism for setting up varying bonus credits or give-aways at varying (e.g., increasing or decreasing) levels based on voucher use (e.g., purchasing vouchers, goods, or services).

Referring back to the voucher management procedure of FIG. 1, an offer list may then be compiled from one or more merchant offers for each user based on one or more user characteristics in operation 104. For each user, a voucher for each offer in the compiled offer list may then be provided to each user's client device so that such voucher is displayable and purchasable at a voucher purchase price in operation 106.

FIG. 3B illustrates one example implementation of a user interface for offering vouchers via a voucher management system to a user in accordance with one embodiment of the present invention. As shown, a user is presented with vouchers 352a, 352b, and 352c that pertain to respective merchant offers. The vouchers 352a-352c include associated voucher purchase prices 354a, 354b, and 354c, respectively. Although the illustrated voucher purchase prices 354a-354c are shown as varying, the voucher prices can be equal.

Each voucher can relate to a particular merchant offer specifying a discount or promotional offer. As shown, voucher 352a includes a discount in the form of a monetary reduction of $25 off the original price of a Brand X shirt purchased from merchant Store X. Voucher 352b includes a discount in the form of a $10 credit for purchasing entrée from Café Y merchant. Voucher 352c includes a discount in the form of a 25% price reduction on a car tune-up service from Auto X merchant.

In the illustrated example, the voucher purchase price for each offer is a nominal amount that is significantly less than the discount or resulting purchase price of each associated good or service. In alternative embodiments, the voucher purchase price may equal the discounted purchase price of the good or service. For instance, if the Brand X shirt price is $40 (after the discount of $25), the voucher purchase price may be equal to $40. The user then can purchase the Brand X shirt by purchasing the voucher without paying an additional charge for purchasing such shirt.

The voucher may also include one or more limitations on the voucher purchase or discount use, such as an expiration date or time period and as described further herein. As shown, voucher 352b has an expiration date of Nov. 30, 2012, and voucher 352c has an expiration date of Jan. 1, 2013. Each voucher may be presented with any suitable number and type of limitations, in addition to an expiration date. The merchant may also specify no expiration date.

After one or more users purchase a voucher from their respective voucher list, a reward may then be remitted to one or more users based on a portion of the voucher proceeds in operation 108. The reward may be in the form of a monetary or fiat currency reward. For instance, the fiat currency is specified as a type of named credits (e.g., Voucher Credits) or purchase points, which may be divisible into fractional units to facilitate division and allocation of such fiat currency across multiple users, merchants, or other entities. In general, the remitted reward is related to at least a portion of the voucher proceeds and doesn't necessarily come directly from the same funds that were obtained from users who purchased vouchers. That is, the reward can come from various other sources, besides the obtained voucher proceeds. By way of examples, the reward can originate from one or more merchants, another fund or a loan from a third party (i.e., an entity other than the voucher users or voucher platform providers), and the amount of the reward can be selected to not exceed the voucher proceeds.

One or more users, who have purchased vouchers, may then use a purchased voucher to buy the associated good or service from the merchant or from an entity affiliated with the merchant in operation 110 (if the good or service of the voucher were not purchased by purchasing the voucher). A voucher may simply represent an offer, which the user is accepting upon purchase of the voucher. In other examples, a voucher can be purchased prior to redeeming an offer. That is, the voucher is purchased at a first price and then the voucher is redeemed by the user accepting the related offer (e.g., buying a $10 shirt with a voucher, which was purchased for $1).

In the later example, a purchased voucher may be used to purchase an associated good or service using any suitable technique. For example, the user may be given the option to print out the voucher and present the printed voucher to the designated place for purchasing the associated good or service. The user may also be given an option to display a bar code, a QR code or other identifying code for the purchased voucher on their mobile device (e.g., smartphone 203 or PDA 204) to the merchant.

In another example, the user may be provided with any suitable electronic or digital mechanism for purchasing the good or service using a voucher at the physical store or remotely (e.g. an online transaction) using a mobile device. For instance, a user's mobile smartphone can include a near field communication (NFC) device that operates to store digital payment information (e.g., credit card information, vouchers, loyalty cards, etc.) and then securely transmit (or receive) such information by merely tapping the mobile device (or bringing the mobile device within, for example, 4 cms to a payment device at a merchant store). The payment information can be transmitted wirelessly using the NFC protocol from the mobile device to the merchant's NFC reader device (or other device) and then to any one or more servers (e.g., including a merchant server 210 or voucher management system 207), which then track such payment, voucher use, loyalty points, etc. The mobile device may be in the form of a fob, phone, digital chip or sticker, for example, placed on a credit/debit card, etc. The voucher may be downloaded to a user's mobile device via any suitable network and then used with the electronic payment mechanism (e.g., NFC). Other types of mobile payment technology, such as SMS (short message service) based transactional payments, direct mobile billing, mobile web payments (WAP or wireless application protocol) may be utilized.

As users provide their vouchers to merchants so as to buy a good or service, the merchants redeem the used vouchers in operation 112. For example, in one embodiment, a merchant may provide redemption information regarding each purchase, voucher, and user to the voucher management system 207 via any client device, e.g., 201 or via a merchant server 210. The redemption information may be retained by the voucher management system 207 in one or more voucher databases, e.g., 208. However, it is not a required function for merchants to communicate use of the voucher to the voucher management system 207 or to the voucher and user database 208.

Any one or more steps of the voucher management procedure 100 may continue or be repeated for multiple users, merchants, and offers at any suitable times. Additionally, any of the steps of procedure 100 may occur in parallel or series with respect to different users, merchants, and offers.

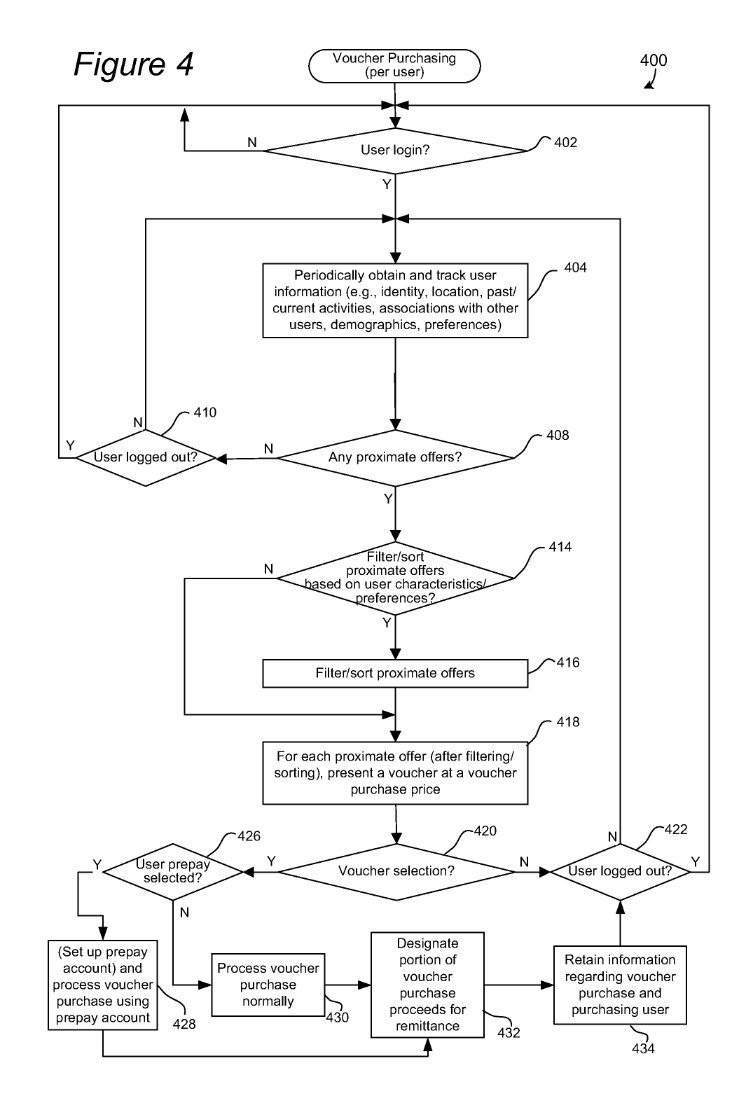

FIG. 4 is a flowchart illustrating a procedure 400 for handling voucher purchasing in accordance with one example implementation. Initially, it may be determined whether a user has performed or initiated a login procedure in operation 402. A user login is optional and the procedure may simply be triggered in response to a user accessing the voucher platform through a web site of a voucher platform server (e.g., 207) or an application on his/her client device (e.g., 202, 203, or 204).

User information pertaining to the current user may be periodically obtained and tracked in operation 404. Such information may be obtained from a third party social network application, from a third party database or information service, or from information and data captured directly by the voucher platform, by way of example. User information may include any suitable characteristic that is associated with the current user. By way of examples, user information for a particular user may include identity, location, past or current activities, demographics (e.g., gender, age, income level, education level, location, place of birth, date of birth, occupation, measures of wealth or assets, etc.), preferences, interests, favorite things, favorite color(s), favorite activities, favorite products, favorite merchants, favorite holidays, hobbies, user identities of other users that are directly or indirectly associated with the current user (e.g. through a social network application), related merchant transactions information provided by a third party, etc.

User information may be stored and tracked by the platform in one or more storage devices, such as voucher database 208. For instance, each time any particular user information regarding a particular user is obtained, the particular user information may be stored in association with the particular user. Specific information regarding vouchers purchased, acquired and/or utilized may be stored with respect to a particular user. Counts of particular types of user information may also be stored in association with the particular user. Table 1 is an example of user information that is tracked for a user who has a user identity of “Bob1234” and who has completed 5 voucher purchase transactions, 2 voucher redemptions, and 10 logins.

TABLE 1

| | Voucher | Voucher | |
|---|---|---|---|
| | Purchase | Redemption | Login |
| User ID | Count | Count | Count |
| Bob1234 | 5 | 2 | 10 |

Other types of user information, such as monetary amounts for voucher purchase and redemption and such as described herein, may be tracked. Additionally, user information may be associated with any suitable type of user identifier, such as a login name and/or an identifier that is tied to the client device, which the user is using to access the platform. For example, the user identifier can be a MAC address of the client device. Counts or monetary amounts may be tracked for individual vouchers or for all vouchers or a set of vouchers.

Although the illustrated process 400 includes periodically obtaining user information during a specific operation 404, it is readily apparent that user information may be periodically obtained and tracked in one or more processes that are each separate from other operations of process 400. That is, user information may be obtained at any suitable time and at any suitable frequency. Additionally, user information may be obtained and tracked even if a user is not logged onto the voucher platform anymore. For example, user information regarding redemption of a voucher by a user may be obtained by the platform in response to such redemption.

In another example, user information that specifies a user's friends may be provided to the voucher system by a social network system (e.g., from social network database 213 of social network system 212), such as Facebook or Google+. That is, any user who is directly associated with a particular user through a social network application may be identified by user information from a social network application. The voucher platform 207 may also provide a social network capability for users to directly associate with other users, independently of use of vouchers. Voucher use activity of members of a particular user's associated user group may also be determined based on obtaining and tracking user activity information for users who are identified as members of the same social group as the particular user.

A portion of obtained user information can be used to determine whether there are any offers that are associated with locations that are proximate to the user's current or home location in operation 408. For instance, a user's geographical location may be obtained and compared with the geographical location of where the goods or services of particular offers are to be purchased. The user may only be presented with offers for goods or services that are conveniently located to the user's location. The user's location may be determined using global positioning satellite (GPS) technology that is integrated into his/her mobile device. In this embodiment, the voucher platform obtains the current GPS location of the user's mobile device from which such user is accessing the voucher platform.

Other mechanisms, besides GPS, may be used to obtain the user's current or home location. For example, the user's location may be alternatively obtained from the user entering his or her current or home location in response to a query from the platform. The user's location may also be based on user information, such as the user's home or business address, which was entered by the user via any suitable application that was later pushed to or obtained by the voucher platform system. The user's location does not have to be the user's current location. That is, the user's location may simply represent a user's preferred or selected location. For example, the user may enter a location for which the user is interested in obtaining offers, such as a future vacation location.

If there are no proximate offers, it may then be determined if the user has logged out (or quit accessing the platform) in operation 410. If the user has logged out (or quit accessing the platform), the procedure may again wait for a user to log in (or access the platform) in operation 402. If the user has not logged out (or stopped accessing the platform), user information may continue to be periodically obtained in operation 404 and it may then be determined again whether there are any proximate offers in operation 408.

If proximate offers are found in operation 408, it may also be determined whether the proximate offers are to be sorted or filtered based on user characteristics or preferences in operation 414. If the proximate offers are to be filtered or sorted, such proximate offers are then filtered and sorted in operation 416. Otherwise, this filtering or sorting step is skipped.

The proximate offers may be sorted or filtered based on any suitable criteria provided by the user or automatically implemented by the platform. The platform may allow a user to select an option to filter or sort offers based on interest topic, price, discount amount, give-aways, location, general popularity, popularity amongst a user's specific social network, merchant name, date of expiration, offers related or similar to the user's past activities, etc. Filter or sort options may be presented to the user before or after proximate offers are presented to such user. For example, the platform may provide a GUI that includes one or more pull-down menus or radio buttons for selecting different filtering or sorting options. Alternatively, the platform may provide a speech-recognition or other style of interface.

The platform may also automatically filter or sort proximate offers based on previously obtained user information, such as preferences, income level, location, voucher use limits, merchant limits, etc. The platform may automatically implement filtering based on user criteria specified by the platform, on a pre-determined basis by the user or a merchant as described further herein. That is, automatic filtering may include removing offers that have been determined to not pertain to relevant user information. For instance, offers for goods or services, which are not within a user's interest areas, may be removed from the list of offers to be provided to the user. Certain offers may be designated by the merchant as only being presented to users who have particular qualities, such as certain income levels, interests, gender, residential location (which may serve as a proxy for income level). If a user does not meet a particular offer's designated user qualities, such offer is filtered from the proximate offer list. Other user criteria for offers may include a certain level of user activity before a particular offer is presented to a user. For instance, merchants or the platform may specify that certain voucher offers are to be provided only to users who have bought a predefined threshold count or monetary amount of goods, services, or vouchers.

Merchant offer requirements may be tracked by the platform based on information entered by a merchant during offer set up. Table 2 is an example of offer criteria that may be specified by merchants and tracked for particular offers.

TABLE 2
Voucher Purchase Criteria

| | Voucher | Voucher | Good/Svc | Good/Svc. |
|---|---|---|---|---|
| | Purchase | Purchase | Purchase | Purchase |
| Offer | Monetary | Count | Monetary | Count |
| ID | Threshold | Threshold | Threshold | Threshold |
| Offer1 | 0 | 0 | $100 | 0 |
| Offer2 | 0 | 0 | 0 | 10 |

As shown in Table 2, each offer may be identified by an Offer ID, which is then associated with the following user criteria: Voucher Purchase Monetary Threshold, Voucher Purchase Count Threshold, Good or Service Monetary Threshold, and Good or Service Count Threshold. If a merchant does not specify one or more user criteria for a particular offer, the platform may automatically enter a zero for such criteria. Otherwise, if a merchant specifies an offer criteria, a user must have purchased $100 of such merchant's goods or services (as shown), for a particular offer (Offer1) to be made available to that user, then this $100 threshold is associated with such particular offer. Additionally, a merchant may specify that certain offer criteria may be met by the aggregate activity of the members of an associated group of users. Similarly, the platform may also automatically assert particular user requirements for individual users or associated groups of users in relation to all or a portion of offers, rewards, etc.

Regardless of whether the proximate offers are filtered or sorted, a voucher at a voucher purchase price may be presented for each proximate (and sorted/filtered) offer in operation 418. For instance, FIG. 3B illustrates a screen shot of voucher offers 352a-352c being presented at particular voucher purchase prices 354a-354c, respectively. This screen shot may be provided by an application on a client device of a user in cooperation with the voucher system (e.g., 207).

It may then be determined whether a voucher has been selected in operation 420. For instance, it is determined whether the user has clicked on a “buy this voucher” button so as to purchase such voucher. If a voucher has not been selected, the process may again check whether the current user has logged out (or stopped platform access) in operation 422. If the current user has logged out (or quit accessing the platform), the procedure may again wait for a user to log in (or access the platform). If the current user has not logged out (or stopped accessing the platform), the process may again check for proximate offers (and possibly present an updated offer list) based on any newly obtained user information (step 404).

When a voucher is selected for purchase, it may then be determined whether a user prepay option has been selected in operation 426. If a prepay option has not been selected, a voucher purchase is processed normally (without a prepay account) in operation 430. If a prepay option is selected, a prepay account may then be set up (if not set up already) and a voucher purchase is processed using such prepay account in operation 428. For example, a user may choose to set up a prepay account with a particular amount of money (e.g., $50) for purchasing vouchers. A user may prefer a prepay option for purchasing vouchers that are priced at nominal amounts (e.g., less than $1) so that the user does not have to go through a lengthy purchasing process (e.g., entering credit card or banking information) for each low priced voucher. This option simplifies the voucher buying process and encourages users to purchase more vouchers.

For either a prepay purchase or a non-prepay purchase, a portion (or all) of the voucher purchase proceeds may be designated for remittance in operation 432. Information regarding the voucher purchase and purchasing user may also be retained in operation 434. The procedure may then check again whether the current user has logged out (or stopped accessing the platform) and continue providing relevant offers to logged in (or accessing) users.

Voucher purchase proceeds may be designated for remittance in any suitable manner. For example, the total proceeds monetary amount may be tracked and a particular percentage of such total proceeds may be designated as remittance to the particular purchasing user or to any other users of the voucher platform, including the merchants, as described further herein. The actual remittance, of course, is not required to be sourced directly from the voucher purchase proceeds, but can be simply related to the purchase proceeds in some way. For instance, the actual funds for remittance may come from a loan or some other funding source, with the amount of such remittance being based on or related to how much voucher purchase proceeds are collected.

The retained information may include anything regarding the voucher purchase, as well as the redemption aspects of using the voucher if relevant. By way of example, user voucher purchase counts or monetary amounts may be tracked for the particular user, such as illustrated in Table 1 and described further herein.

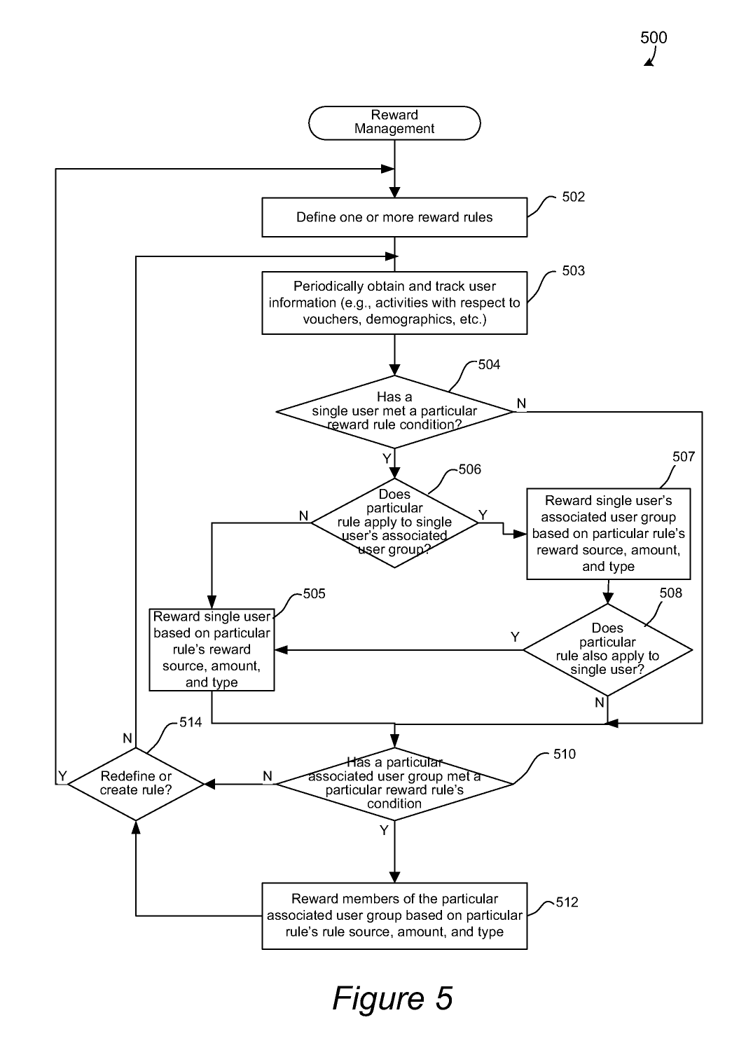

FIG. 5 is a flowchart illustrating a reward management procedure 500 in accordance with a specific embodiment. Initially, one or more reward rules may be defined in operation 502. The one or more reward rules may specify one or more single user activity conditions and/or associated user group activity conditions, reward sources, reward amounts, reward types, etc.

Any number and type of reward rules may be automatically defined by the voucher platform and/or specified by one or more merchants (e.g., during an offer set up). There may be a calculation for whether to remit a reward to a particular user or a group of users and how much to remit based on one or more metrics, such as voucher purchase count or total monetary amount for the particular user, voucher purchase count for the particular user's social group, good or service purchase count or total monetary amount for the particular user or particular user's social group, etc.

Each voucher and associated offer can be associated with a specific reward rule for such particular voucher and offer. In a decreasing amount example, the first 100 users to buy a particular offer will receive 15% back; the next 100 will receive 10% back; and everyone else will receive 5% back. In an increasing amount example: if 100 customers buy a particular offer, then everyone will receive 5% back; and if 200 customers buy this offer, then everyone receives 10% back; etc. In both of the above decreasing and increasing discount cases, the reward is remitted either concurrently or in the future once certain targets are met.

Reward rules may also pertain to certain activity thresholds being met by a single user with the reward being then applied to only the single user, only the single user's associated user group excluding the single user, or the single user's associated user group including the single user. For instance, if a particular user purchases a particular number of vouchers, goods, or services, such particular user may then be rewarded a particular reward amount at a certain percentage of their voucher purchase amount. In another example, if a particular user purchases the particular number of vouchers, goods, or services, members of the particular user's social group (e.g. friends who are designated through a social application) are rewarded a certain percentage of the voucher proceeds from the particular user and/or the social group members. A reward may also be given randomly based on variables that do not pertain to user activity criteria with respect to vouchers. For example, rewards can be given based on timing, probability, etc.

Reward rules can specify that a reward is to go to a voucher purchaser, good or service purchaser, platform user, a merchant, or any suitable entity. Reward rules can specify certain sources for the funding of such reward. For instance, some rewards may come from a reward receiver's own voucher purchase proceeds, other users' voucher proceeds, proceeds from sale of a particular voucher, proceeds from sales of vouchers for offers from a particular merchant, etc. Rewards rules may also specify that at least a portion of a reward is to be taken from bonus credits provided by a merchant. Rewards may also take the form of give-aways from the merchant (or platform) that are given based on a calculation having a variable set by the merchant or by the platform (e.g., probability).

User information is also periodically obtained and tracked, as represented by operation 503. For instance, user information may pertain to total count of voucher purchases, total monetary amount of voucher purchases, total count of user logins into the platform, total prepay amounts, total number or monetary amount of vouchers given to other users, total number of other users who a particular user has invited to join the voucher platform, total use of the platform by voucher purchaser or merchant, total amount of goods and services purchased through the platform or via a voucher by a user or a group of users, total amount of goods and services transacted outside of the platform by a user or a group of users wherein such information may be provided by a merchant, a third party payments processor or other information provider, etc. User information may be collected and tracked at any suitable time, such as when a user logs in, purchases a voucher, uses a voucher, invites another user, etc.

Rewards (including rebates, bonus credits, give-aways) may be given to users at any suitable time. For example, users may be notified of their reward contemporaneously at the time of a voucher acquisition. Additionally, reward conditions may include timing conditions, such as giving a remittance type reward back to a merchant after a user has used a voucher for an offer to purchase goods or services from such merchant.

Referring to the illustrated procedure of FIG. 5, it may be determined whether a single user has met a particular reward rule condition in operation 504. In other words, it is determined whether a single user's aggregate activities have met the criteria of any reward rules for single users. It may then be determined whether the particular rule also applies to the single user's associated user group in operation 506. If the reward rule does not apply to the associated user group, the single user is only rewarded based on such particular reward rule's reward source, amount, and type in operation 505. Otherwise, the single user's associated user group may then be rewarded based on the particular rule's reward source, amount, and type in operation 507. It may also then be determined whether the particular rule also applies to the single user (i.e., includes the single user) in operation 508. If the particular reward includes the single user, the single user is rewarded based on such particular reward rule's reward source, amount, and type in operation 505. Otherwise, if the rule excludes the single user, this operation 505 is skipped.

When a single user meets a particular reward rule, other users within the single user's social group can be rewarded, even if such other members have not performed the same level of activity as the single user. Other rules may specify requirements for a social group's aggregate activities, which may include one or more members together acting to achieve the rule's criteria. Thus, it may also be determined whether a particular associated user group has met a particular reward rule's condition in operation 510. For example, a rule may specify that a social group is required to purchase 10 vouchers before being rewarded. This rule is met, for example, when a first social group member purchases 5 vouchers and a second group member purchases 5 vouchers. If a particular reward rule condition has been met, all or a portion of the members of such particular associated user group may then be rewarded in operation 512. For example, the reward may go to only the two contributing members or all of the members, including contributing and noncontributing members, in the previous example. Otherwise, this reward operation is skipped.

The reward procedure 500 may also include an operation (e.g., 514) for determining whether a rule is being redefined or created. For example, a merchant can set up a new offer with bonus credits being given under particular conditions. In another example, a new voucher with voucher purchases remittance rules may be set up. If a rule is being redefined or created, such new or modified rule is then defined or redefined in operation 502 and the reward process for checking whether particular rule conditions are met for a single user and/or associated user group are repeated. Otherwise, if a rule is not being redefined or created, the rule definition operation is skipped and the rule checking operations are repeated for the current set of rules.

The voucher platform may also include a mechanism for a user to provide a gift or invitation to another user. A gift may take the form of 1) monetary credit units for buying vouchers, goods or services that the giving user previously acquired, 2) monetary credit units that have been remitted to the giving user, or (3) a voucher. For instance, the platform may allow the user to select vouchers or credit units from their own account to give to other users. The giving user may also be given an option to purchase vouchers or credits for a specified user. The giving user can specify a receiving user via any suitable identity, such as voucher platform identity, email address, social network identity, etc. The giving user may also be allowed to specify limits on each gift. For example, credits can only be used for certain merchant vouchers, goods, or services or for certain categories of vouchers, goods or services. The platform may also allow the user to select an option for sending invitations to specified users to purchase particular vouchers or to join the voucher platform. Such gifts or invitations may be tracked by the platform for a particular user to receive additional rewards for giving gifts or inviting other users.

Embodiments of the present invention may be implemented in any suitable network environment. The network may take any suitable form, such as a wide area network or Internet and/or one or more local area networks (LAN's). The network may be in the form of a data, mobile, cellular, plain old telephone network (POTN), or any combination thereof. Referring back to FIG. 2, the network 200 may include any suitable number and type of devices, e.g., routers and switches, for forwarding requests from each client to a particular server application, forwarding application results back to the requesting clients, or forwarding data between various servers.

Embodiments of the present invention may also be practiced in a wide variety of network environments (represented by network 104) including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, mobile networks, etc., or any combination thereof. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be affected or employed at different locations.

The disclosed techniques of the present invention may be implemented in any suitable combination of software and/or hardware systems, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

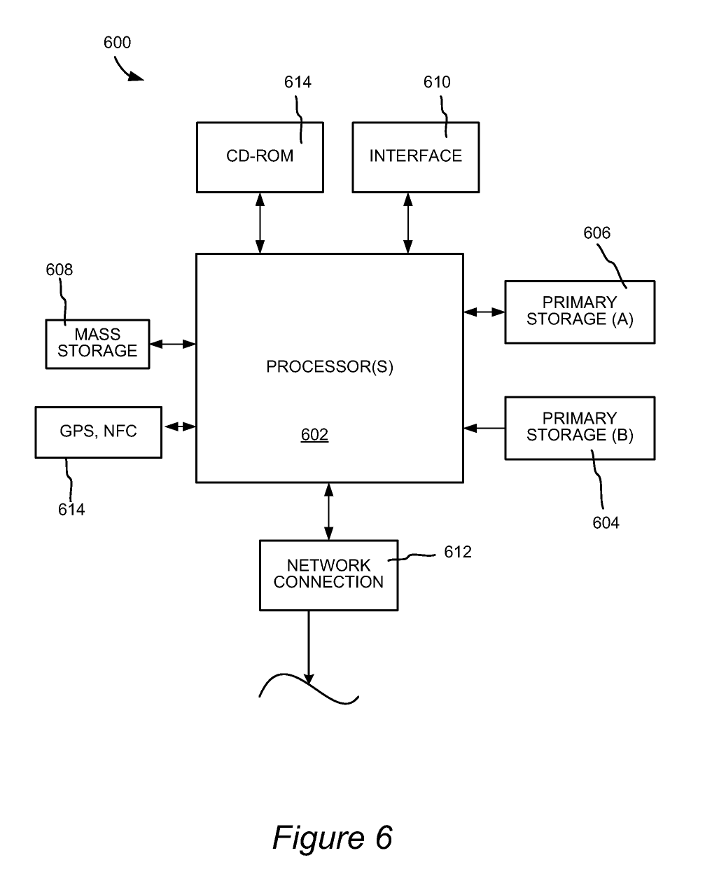

FIG. 6 illustrates a typical computer system that, when appropriately configured or designed, can serve as a voucher, server, or client system. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general-purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described herein. A mass storage device 608 is also coupled bi-directionally to CPU 602 and provides additional data storage capacity and may include any of the computer-readable media described herein. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that connects to one or more input/output devices such as video monitors or displays, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications network using an external connection as shown generally at 612. With such a connection, it is contemplated that the CPU might receive information from the network, or might output information to the network in the course of performing the method steps described herein. CPU 602 may also be coupled with any other suitable internal devices, such as a GPS device or NFC device 614.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

A network may also include mass storage, such as network attached storage (NAS), a storage area network (SAN), or other forms of computer or machine readable storage media, for example. Regardless of the system's configuration (e.g., client or server), it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the present invention relates to machine readable storage media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for selling a discount or promotional voucher to a user of a mobile or data network, the method comprising:
(a) providing a first voucher, which specifies both a voucher purchase price for purchasing such first voucher and a discount of an original purchasing price for purchasing a good or service from a first merchant using such first voucher, to a computing device that is associated with a first user and that is configured to display such first voucher on a display of such computing device,
wherein the discount is specified as a price reduction, a buyer credit or a rebate that is applied to the original purchase price by use of such first voucher to purchase the good or service,
wherein the first voucher is provided from a platform that is configured to provide a plurality of vouchers, including the first voucher, for a plurality of discounts offered by a plurality of different merchants,
wherein the voucher purchase price for purchasing the first voucher is less than the discount that is obtainable by use of such first voucher to purchase the good or service and is less than a price of the good or service after the discount has been applied, if determinable from the terms of the voucher; and
(b) after the first user purchases the first voucher at the voucher purchase price in a first transaction, remitting to one or more users, including the first user, a monetary or fiat currency reward that is related to at least a portion of proceeds that were obtained from a plurality of voucher transactions with respect to a sale of one or more of the plurality of vouchers that occurred prior to the first transaction or wherein such reward is related to proceeds from another source.

2. The method of claim 1, further comprising repeating operation (a) for each of a first plurality of users to purchase selected ones of the plurality of vouchers from selected ones of the different merchants via the platform, and repeating operation (b) for each of a second plurality of users, and wherein a monetary or fiat currency reward is remitted to one or more of the second plurality of users even if such one or more users have purchased vouchers and have not used their purchased vouchers to purchase associated goods or services.

3. The method of claim 1, wherein the reward is related to at least a portion of proceeds that were obtained from a plurality of voucher transactions with respect to a sale of one or more of the plurality of vouchers that occurred prior to the first transaction, the method further comprising:
prior to providing the first voucher to the computing device of the first user, providing a second voucher to a second computing device that is associated with a second user and that is configured to display such second voucher on a display of such second computing device, wherein the second voucher is provided to the second computing device from the platform; and
after the second user purchases the second voucher at a second voucher purchase price in a second transaction, collecting such second voucher purchase price as part of the proceeds that were obtained from the plurality of transactions that occurred prior to the first transaction without remitting any portion of such proceeds to the second user in response to the second transaction.

4. The method of claim 1, wherein the reward is represented in the platform as a fiat currency.

5. The method of claim 4, wherein the fiat currency is specified as a plurality of named credits or purchase points, which are divisible into fractional units to facilitate division and allocation of such fiat currency across multiple users, merchants, or other entities.

6. The method of claim 1, further comprising:
to the computing device of the first user, providing a pre-pay option for the first user to purchase a plurality of monetary or fiat currency credits that can later be used to purchase one or more of the plurality of vouchers.

7. The method of claim 1, wherein the first voucher is integrated into a digital payment mechanism for the first user to purchase the good or service via a mobile or data network.

8. The method of claim 1, further comprising:
providing a give-away promotion with the first voucher so that the first user is eligible to receive a free merchant offering following said first user's acquisition of the first voucher in response to a chance-based calculation that the free merchant offering is to be provided to the first user, wherein an aspect of the calculation is specified by the first merchant.

9. The method of claim 1, further comprising:
determining a location of the first user, and wherein such first voucher is provided to the computing device of the first user based on determining that a place of business for the good or service of the first voucher is proximate to the location of such first user.

10. The method of claim 2, wherein whether to remit the reward to one or more users and/or a variable used in the calculation of the amount of the reward provided to such one or more users is based on a metric pertaining to all or a portion of such one or more of the plurality of users' past aggregation of activities in relation to the plurality of vouchers or a plurality of merchant related transactions.

11. The method of claim 2, wherein an amount of the discount specified by one or more vouchers that are provided to one or more of the plurality of users is based on a metric pertaining to all or a portion of such one or more of the plurality of users' past aggregation of activities in relation to the plurality of vouchers or a plurality of merchant related transactions.

12. The method of claim 2, wherein the reward to one or more of the plurality of users also includes bonus credits to the one or more of the plurality of users from one or more of the different merchants based on a metric pertaining to all or a portion of such one or more of the plurality of users' past aggregation of activities in relation to the plurality of vouchers or a plurality of merchant related transactions.

13. The method of claim 2, wherein the second plurality of users include a plurality of associated users to which a reward is remitted based on a determination that such plurality of associated users are associated with each other by a direct association each associated user has with at least one of the first plurality of users through a social network application, wherein the association exists independently of the plurality of vouchers and use of such vouchers.

14. The method of claim 13, wherein an amount of the reward is determined and remitted to one or more of the associated users based on a metric pertaining to all or a portion of such associated users' collective utilization of the plurality of vouchers or a plurality of merchant related transactions.

15. The method of claim 14, wherein the amount of the reward is selected from a pre-determined plurality of increasing or decreasing values that are specified by the first merchant.

16. The method of claim 13, wherein the reward is in the form of bonus credits provided by the first merchant and wherein use of such bonus credits is limited to vouchers, goods or services that pertain to the first merchant.

17. The method of claim 16, wherein the bonus credits are allocated based on all or a portion of said associated users' collective activities with respect to the plurality of vouchers or a plurality of merchant related transactions.

18. The method of claim 13, wherein an amount of the discount of the first voucher as provided to the first user is based on a metric that pertains to a collective or individual activity that is performed by one or more of the associated users with respect to the plurality of vouchers or a plurality of merchant related transactions.

19. The method of claim 18, wherein the amount of the discount is selected from a pre-determined plurality of increasing or decreasing values that are specified by the first merchant.

20. The method of claim 1, wherein the first voucher is provided to the first user based on user information pertaining to the first user, which is accessible by the platform, meeting one or more user criteria that are specified by the first merchant.

21. The method of claim 1, wherein the discount's amount depends on whether user information pertaining to the first user, which is accessible by the platform, meets one or more user criteria that are specified by the first merchant.

22. The method of claim 1, wherein the reward includes bonus credits provided by the first merchant that are remitted based on one or more criteria pertaining to a plurality of users that are specified by the first merchant and such bonus credits are remitted based on user information that is accessible by the platform, wherein use of the bonus credits are limited to transactions pertaining to the first merchant.

23. The method of claim 2, wherein one of the remitted rewards is remitted to an associated subset of the plurality of users that are all directly associated to at least one same user through a social network application and such remitting is based on whether user information pertaining to the associated subset of users, which is accessible by the platform, meets one or more aggregate criteria pertaining to said associated subset of users that is specified by the first merchant.

24. The method of claim 2, wherein the reward has a value that is selected from a pre-determined plurality of increasing or decreasing values that each depend on whether user information pertaining to the first or second plurality of users meets one or more user activity criteria.

25. The method of claim 2, wherein the reward includes bonus credits provided from the first merchant and a value of such bonus credits are selected from a pre-determined plurality of increasing or decreasing levels that each depend on whether user information pertaining to the first or second plurality of users indicates that such first or second plurality of users meets one or more user activity criteria specified by the first merchant.

26. The method of claim 2, wherein a discount of at least one of the provided vouchers is selected from a pre-determined plurality of increasing or decreasing values that each depend on whether user information pertaining to the first or second plurality of users meets one or more user activity criteria.

27. The method of claim 2, further comprising:
receiving a plurality of gifts that are specified by a plurality of giving users to be offered to selected one or more of the first or second plurality of users, wherein each gift is in the form of 1) monetary credit units for buying vouchers that the giving user previously acquired, 2) monetary credit units that have been remitted to said giving user, or (3) a voucher; and
providing such gifts to such selected one or more of the first or second plurality of Users.

28. The method of claim 25, wherein one or more of the plurality of gifts specify limitations on use of said gift.

29. An apparatus comprising at least a processor and a memory, wherein the processor and/or memory are configured to perform the following operations:
(a) providing a first voucher, which specifies both a voucher purchase price for purchasing such first voucher and a discount of an original purchasing price for purchasing a good or service from a first merchant using such first voucher, to a computing device that is associated with a first user and that is configured to display such first voucher on a display of such computing device,
wherein the discount is specified as a price reduction or a buyer credit that is applied to the original purchase price by use of such first voucher to purchase the good or service,
wherein the apparatus is in the form of an apparatus that is operable to provide a plurality of vouchers, including the first voucher, for a plurality of discounts offered by a plurality of different merchants,
wherein the voucher purchase price for purchasing the first voucher is less than the discount that is obtainable by use of such first voucher to purchase the good or service and is less than a price of the good or service after the discount has been applied, if determinable from the terms of the voucher; and
(b) after the first user purchases the first voucher at the voucher purchase price in a first transaction, remitting to one or more users, including the first user, a monetary or fiat currency reward that is related to at least a portion of proceeds that were obtained from a plurality of voucher transactions with respect to a sale of one or more of the plurality of vouchers that occurred prior to the first transaction or wherein such reward is related to proceeds from another source.

30. At least one computer readable storage medium having computer program instructions stored thereon that are arranged to perform the following operations:
(a) providing a first voucher, which specifies both a voucher purchase price for purchasing such first voucher and a discount of an original purchasing price for purchasing a good or service from a first merchant using such first voucher, to a computing device that is associated with a first user and that is configured to display such first voucher on a display of such computing device,
wherein the discount is specified as a price reduction or a buyer credit that is applied to the original purchase price by use of such first voucher to purchase the good or service,
wherein the first voucher is provided from a platform that is configured to provide a plurality of vouchers, including the first voucher, for a plurality of discounts offered by a plurality of different merchants,
wherein the voucher purchase price for purchasing the first voucher is less than the discount that is obtainable by use of such first voucher to purchase the good or service and is less than a price of the good or service after the discount has been applied, if determinable from the terms of the voucher; and
(b) after the first user purchases the first voucher at the voucher purchase price in a first transaction, remitting to one or more users, including the first user, a monetary or fiat currency reward that is related to at least a portion of proceeds that were obtained from a plurality of voucher transactions with respect to a sale of one or more of the plurality of vouchers that occurred prior to the first transaction or wherein such reward is related to proceeds from another source.
